(19) United States
(12) Patent Application Publication
(10) Pub. No.: US 2010/0193419 A1
(43) Pub. Date: Aug. 5, 2010

(54) Normal-Pressure Plasma-Based Apparatus for Processing Waste Water by Mixing the Waste Water with Working Gas

(75) Inventors: Jyh-Ming Yan, Taoyuan County (TW); Yung-Chih Chen, Taipei City (TW); Shiaw-Huei Chen, Yonghe City (TW); Ming-Song Yang, Taipei City (TW); Men-Han Huang, Taoyuan County (TW)

Correspondence Address: Jackson Intellectual Property Group PLLC, 106 Starvale Lane, Shipman, VA, 22971, US

(73) Assignee: ATOMIC ENERGY COUNCIL-INSTITUTE OF NUCLEAR ENERGY RESEARCH, Taoyuan (TW)

(21) Appl. No.: 12/643,096

(22) Filed: Dec. 21, 2009

(30) Foreign Application Priority Data
Feb. 5, 2009 (TW) 098103759

(51) Int. Cl. C02F 1/46; C02F 1/72

(52) U.S. Cl. 210/150

(57) ABSTRACT

There is disclosed a normal-pressure plasma-based apparatus for processing waste water by mixing the waste water with working gas. The apparatus includes a waste water supply, a gas supply, a plasma-based processing unit connected to both of the waste water supply and the gas supply, a reservoir connected to the plasma-based processing unit and a washing tower connected to both of the reservoir and the plasma-based processing unit. The plasma-based processing unit and the washing tower are used together to mix the waste water with the working gas at least twice. The plasma-based processing unit produces active substances to decompose organic compounds and eliminate the colors of the organic compounds. Thus, performance in processing the waste water is excellent while the consumption of time and energy is low.

### FIELD OF THE INVENTION

The present invention relates to a normal-pressure plasma-based apparatus for processing waste water by mixing the waste water with working gas at least twice.

### DESCRIPTION OF THE RELATED ARTS

There are three categories of methods for processing waste water, i.e., aeration-based methods, ozone-based methods and plasma-based methods. In an aeration-based method, it takes several days to complete the processing of the waste water. The aeration-based method requires an inexpensive facility but occupies vast space and takes a lot of time. Furthermore, during the aeration of the waste water, there is inevitably odor that troubles people living near the facility.

In an ozone-based method, waste water is processed by using ozone to oxidize and decompose organic substances in the waste water. It takes a shorter period of time to complete the processing of the waste water in the ozone-based method than in the aeration-based method. It however takes several hours to complete the processing of the waste water in the ozone-based method. Furthermore, it is difficult to dissolve the ozone in the waste water, and a large portion of the ozone is lost, and the processing of the waste water is of ten incomplete.

It takes lest time to complete the processing of the waste water in a plasma-based method among these methods. In a typical plasma-based method, high-voltage discharge is conducted to generate plasma in the waste water without or with a small amount of gas introduced into the waste water to create bubbles previously. It however consumes a lot of energy. For example, to reach a rate of 90% of decolorizing of organic dye-related waste water, power consumption is higher 1 kJ/L. The plasma-based method requires a lot of energy. It is therefore not practical to execute a plasma-based method in a large scale.

The present invention is therefore intended to obviate or at least alleviate the problems encountered in prior art.

### SUMMARY OF THE INVENTION

It is the primary objective of the present invention to provide a fast, effective and inexpensive apparatus for processing waste water.

To achieve the foregoing objective, the waste apparatus includes a waste water supply, a gas supply, a plasma-based processing unit, reservoir and a washing tower. A first pipe connects the plasma-based processing unit to the waste water supply. A second pipe connects the plasma-based processing unit to the gas supply. The plasma-based processing unit includes a liquid cyclone tube, a gas cyclone tube and a discharge chamber. The liquid cyclone tube is connected to the first pipe. The gas cyclone tube is connected to the second tube. The discharge chamber includes an anode, a cathode provided around the anode, a dielectric tube provided between the anode and the cathode, a high-voltage power supply for connecting the anode to the cathode, and a cooling water-recycling device provided within the anode. The reservoir is connected to the plasma-based processing unit. The washing tower includes a lower portion connected to the plasma-based processing unit and an upper portion connected to the reservoir.

Other objectives, advantages and features of the present invention will become apparent from the following description referring to the attached drawings.

### BRIEF DESCRIPTIONS OF THE DRAWINGS

The present invention will be described via detailed illustration of the preferred embodiment referring to the drawings.

FIG. 1 is a block diagram of an apparatus for processing waste water by mixing the waste water with working gas at least twice according to the preferred embodiment of the present invention.

FIG. 2 is a cross-sectional view of the apparatus shown in FIG. 1.

FIG. 3 is a cross-sectional view of the apparatus shown in FIG. 2.

### DESCRIPTION OF THE PREFERRED EMBODIMENT

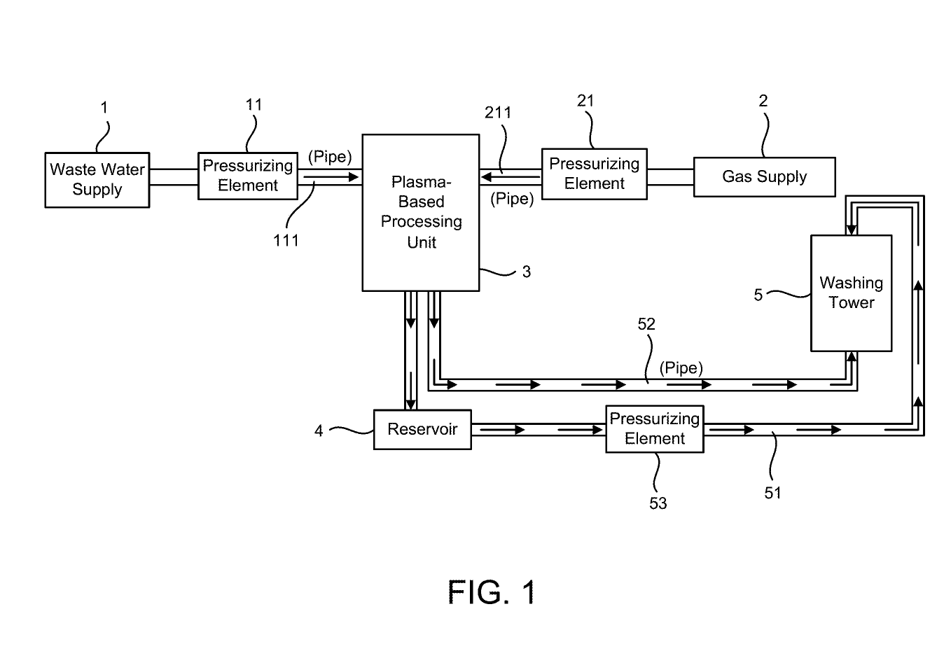

Referring to FIG. 1, there is shown an apparatus for processing waste water by mixing the waste water with working gas at least twice according to the preferred embodiment of the present invention. The apparatus includes a waste water supply 1, a gas supply 2, a plasma-based processing unit 3, a reservoir 4 and a washing tower 5.

The waste water supply 1 is connected to the plasma-based processing unit 3 through a pipe 111. The waste water supply 1 supplies the waste water to the plasma-based processing unit 3 through the pipe 111. A pressurizing element 11 is provided on the pipe 111. The pressurizing element 11 controls the flow rate of the waste water in the pipe 111.

The gas supply 2 is connected to the plasma-based processing unit 3 through a pipe 211. The gas supply 2 supplies the working gas to the plasma-based processing unit 3 via the pipe 211. A pressurizing element 21 is provided on the pipe 211. The pressurizing element 21 controls the flow rate of the working gas in the pipe 211.

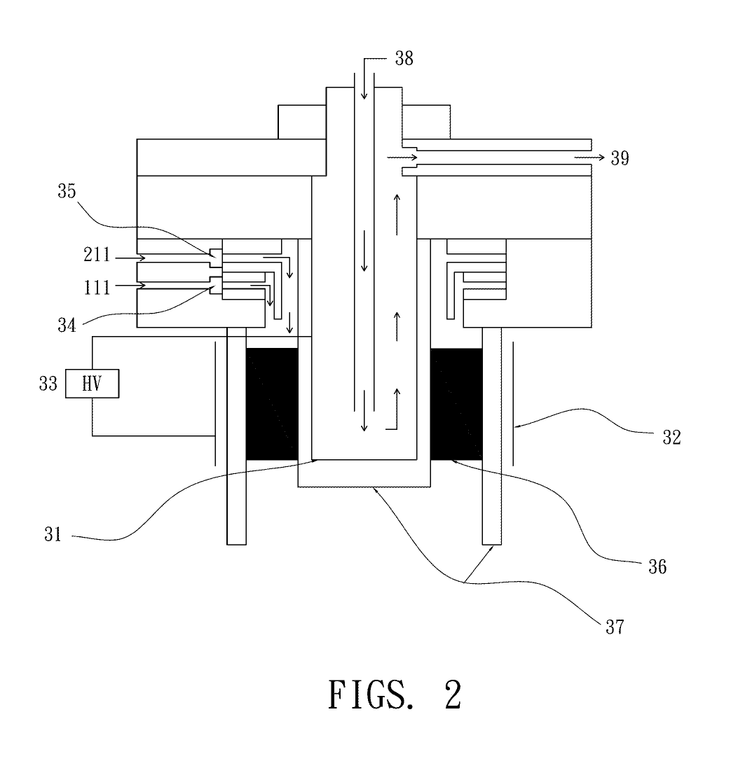

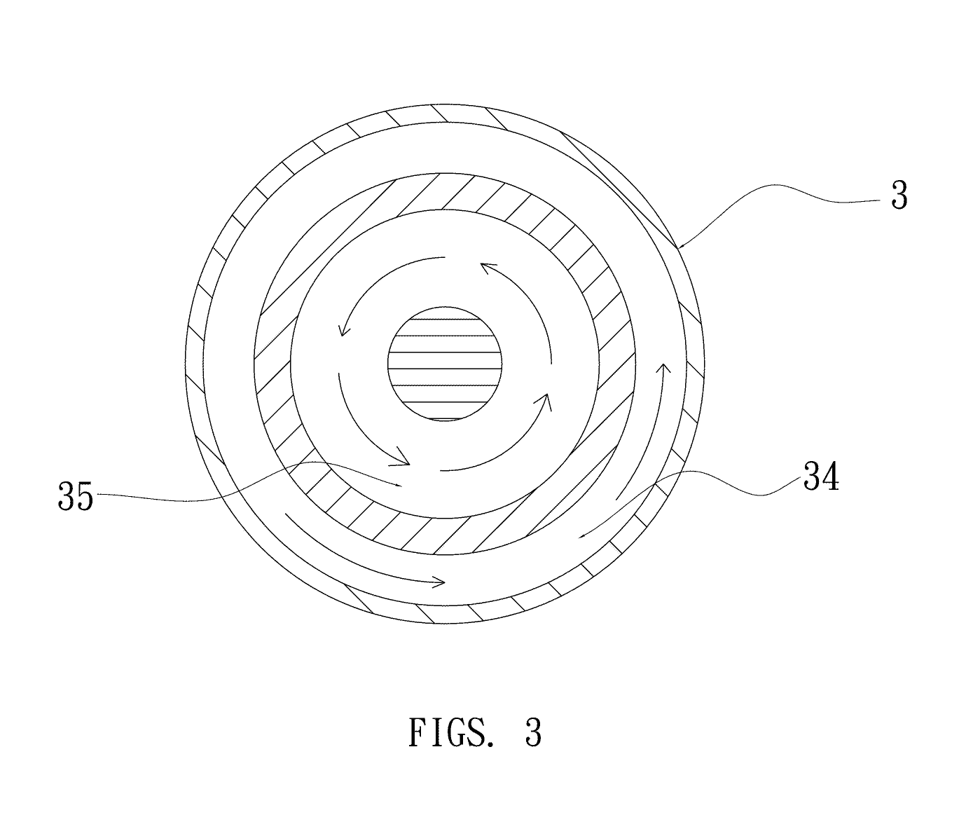

Referring to FIGS. 2 and 3, the plasma-based processing unit 3 includes a liquid cyclone tube 34, a gas cyclone tube 35 and a discharge chamber 36. The liquid cyclone tube 34 is connected to the pipe 111 while the gas cyclone tube 35 is connected to the pipe 211. The discharge chamber 36 is connected to the liquid cyclone tube 34 and the gas cyclone tube 35.

The discharge chamber 36 includes an anode 31, a cathode 31 and a dielectric tube 37. The anode 31 is made of metal with excellent conductivity such as stainless steel, copper and copper alloy. The cathode 32 is made of metal with excellent conductivity such as stainless steel and steel coated with conductive copper alloy. The thickness of the cathode 32 is based on actual operation and can be in a range of 0.1 millimeter to 1.5 millimeters. The dielectric tube 37 can include one layer or two. The dielectric tube 37 is located between the anode 31 and the cathode 32. The dielectric tube 37 is made of an isolating material such as quartz, glass and ceramic materials.

The anode 31 is located within the cathode 32. The anode 31 is connected to the cathode 32 via an external high-voltage power supply 33. The external power supply supplies a high-frequency alternating current or direct-current pulses to generate plasma.

A cooling water-recycling device is used to cool the discharge chamber 36. The cooling water-recycling device is located within the anode 31. The cooling-recycling device includes a pipe 38 for introducing cooling water into the anode 31 and a pipe 39 for removing the cooling water from the anode 31.

The reservoir 4 is connected to the plasma-based processing unit 3. The reservoir 4 receives the waste water from the plasma-based processing unit 3.

A lower portion of the washing tower 5 is connected to the plasma-based process 3 through a pipe 52. An upper portion of the washing tower 5 is connected to the reservoir through a pipe 51. A pressurizing 53 is provided on the pipe 51. The pressurizing element 53 controls the flow rate of the waste water in the pipe 51.

In operation, the waste water supply 1 supplies the waste water to the plasma-based processing unit 3 through the pipe 111. The pressurizing element 11 controls the flow rate of the waste water in the pipe 111. The gas supply 2 supplies the working gas to the plasma-based processing unit 3 via the pipe 211. The working gas can be air for example. The pressurizing element 21 controls the flow rate of the working gas in the pipe 211. The ratio of the working gas over the waste water is about 10 to 30.

After receiving the waste water from the pipe 111, the liquid cyclone tube 34 generates a cyclone of the waste water so that the waste water is expedited. After receiving the working gas from the pipe 211, the gas cyclone tube 35 generates a cyclone of the working gas so that the working gas is expedited. Then, the waste water and the working gas are sent into the discharge camber 36. Because of the cyclones, the waste water is mixed with the working gas quickly. The mixture travels like a water fall down the dielectric tube 37. The mixture contains much more working gas than waster water. Therefore, discharge is conducted in the mixture like the air. The power consumption required by the discharge is low at about 50 to 300 joule/litter. Oxygen, nitrogen, helium, argon, air and/or carbon tetra-fluoride can be introduced as working gas into the discharge chamber 36. The discharge generates plasma from the working gas. The plasma contains active species such as oxygen atoms, nitrogen atoms, O2, N2, OH, O2— and ozone. The active species decomposes or breaks down pollutants in the waste water.

After the decomposition, the waste water is sent into the reservoir 4 from the plasma-based processing unit 3. Then, under the control of the pressurizing element 53, the waste water is sent into the upper portion of the tower 5 via the pipe 51. The waste water falls within the washing tower 5. The working gas is sent into the lower portion of the washing tower 5 from the plasma-based processing unit 3 via the pipe 52. The working gas rises in the washing tower 5. The working gas rushes into the waste water. The working gas is adequately mixed with the waste water again so that a residual portion of the active species decomposes residual pollutants in the waste water. At the same time, the waste water is subjected to aeration while falling to a lower portion of the washing tower 5 from the upper portion of the same. As discussed above, plasma, ozone and aeration are used to process the waste water in the apparatus of the present invention.

The performance of the apparatus of the present invention is better than prior art as shown in Table 1. The apparatus of the present is used to process waste water containing 100 ppm of methyl orange for example. An aeration-based apparatus and an ozone-based apparatus are used to process waste water containing 10 ppm of methyl orange. The apparatus of the present invention reaches a decolorizing rate of 90% within 5 short minutes. It takes 30 minutes to reach a decolorizing rate of 20% with the aeration-based apparatus. It takes minutes to reach a decolorizing rate of 84% with the ozone-based apparatus. Moreover, the power consumption required by the apparatus of the present invention is about 50 to 300 joule/litter that is much lower than it would be required by a conventional plasma-based apparatus.

TABLE 1

| | Aeration | Ozone | Invention |
|---|---|---|---|
| Methyl orange | 10 | 10 | 100 |
| (ppm) | | | |
| Time (min) | 30 | 30 | 20 |
| Decolorizing rate | 20 | 84 | 90 |
| (%) | | | |

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A waste water-processing apparatus comprising:
a waste water supply;
a gas supply;
a plasma-based processing unit comprising:
a first pipe for connecting the plasma-based processing unit to the waste water supply;
a second pipe for connecting the plasma-based processing unit to the gas supply;
a liquid cyclone tube connected to the first pipe;
a gas cyclone tube connected to the second tube; and
a discharge chamber comprising:
an anode;
a cathode provided around the anode;
a dielectric tube provided between the anode and the cathode;
a high-voltage power supply for connecting the anode to the cathode; and
a cooling water-recycling device provided within the anode;
a reservoir connected to the plasma-based processing unit; and
a washing tower comprising a lower portion connected to the plasma-based processing unit and an upper portion connected to the reservoir.

2. The waste water-processing apparatus according to claim 1 comprising a pressurizing element on the first pipe to control the flow rate of waste water in the first pipe.

3. The waste water-processing apparatus according to claim 1 comprising a pressurizing element on the second pipe to control the flow rate of working gas in the second pipe.

4. The waste water-processing apparatus according to claim 1, wherein the gas supply supplies working gas selected from a group consisting of oxygen, nitrogen, helium, argon, air and carbon tetra-fluoride.

5. The waste water-processing apparatus according to claim 1, wherein the anode is made metal selected from a group consisting of stainless steel, copper and copper alloy.

6. The waste water-processing apparatus according to claim 1, wherein the cathode is made of metal selected from a group consisting of stainless steel and steel coated with conductive copper alloy, and the thickness of the cathode is 0.1 millimeter to 1.5 millimeters.

7. The waste water-processing apparatus according to claim 1, wherein the dielectric tube includes at least one layer and is made of a material selected from a group consisting of quartz, glass and ceramic materials.

8. The waste water-processing apparatus according to claim 1, wherein the cooling water-recycling device is used to cool the plasma-based processing unit.

9. The waste water-processing apparatus according to claim 1, wherein the liquid cyclone tube and the gas cyclone tube are used to expedite the waste water and the working gas, respectively so that they can be mixed with each other efficiently, and the ratio of the working gas over the waste water is 10 to 30.

10. The waste water-processing apparatus according to claim 1, wherein the high-voltage power supply provides power selected from a group consisting of a high-frequency alternating current and direct-current pulses.

11. The waste water-processing apparatus according to claim 1, comprising a pressurizing element for transferring the waste water to the upper portion of the washing tower.

12. The waste water-processing apparatus according to claim 1, wherein the waste water falls within the washing tower while the working gas working gas rises in the washing tower and rushes into the waste water so that the working gas is adequately mixed with the waste water again and that residual active species of the working gas decomposes residual pollutants in the waste water.
